(19) United States
(12) Patent Application Publication
(10) Pub. No.: US 2008/0088590 A1
(43) Pub. Date: Apr. 17, 2008

(54) Display Input Equipped Data Entry Device and Methods

(76) Inventors: Ronald Brown, Morgan Hills, CA (US); Daniel Harden, Palo Alto, CA (US)

Correspondence Address: BOYLE FREDRICKSON S.C., 840 North Plankinton Avenue, MILWAUKEE, WI, 53203, US

(21) Appl. No.: 11/858,892

(22) Filed: Sep. 20, 2007

Related U.S. Application Data
(63) Continuation-in-part of application No. 11/406,948, filed on Apr. 18, 2006.
(63) Continuation-in-part of application No. 11/857,435, filed on Sep. 18, 2007.
(60) Provisional application No. 60/846,365, filed on Sep. 20, 2006.

(51) Int. Cl. G06F 3/02

(52) U.S. Cl. 345/168

(57) ABSTRACT

A display-input equipped data entry device and method of configuring and operating it. Sets of images can be assembled into a layout configuration assignable to a particular program, including a particular key combination that can be pressed during operation of the program. An image is assignable to a particular input by dragging it onto an icon representative of that input displayed onscreen on a computer. An existing image, such as from an image file, is convertible into a code used to produce a reduced-pixel input display-compatible image. Such codes can be incorporated into an HTML, XHTML, XML or other web page document such that a computer running a browser equipped with a code scanning module or plug-in reads each code embedded in a web page being viewed causing the associated image to be displayed on a display of an input of a data entry device linked to the computer.

### CROSS REFERENCE TO RELATED APPLICATION(S)

This application is a continuation-in-part of U.S. application Ser. No. 11/406,948, filed Apr. 18, 2006 and is a continuation-in-part of U.S. application Ser. No. 11/857,435, filed Sep. 18, 2007 the entire disclosures of which are expressly incorporated herein. This application also claims priority under 35 U.S.C. § 119(e) in U.S. Provisional Application Ser. No. 60/846,365, filed Sep. 20, 2006, the entire disclosure of which is expressly incorporated herein.

### FIELD

The present invention is directed to a data entry device for use in helping control or operate a processor-equipped apparatus that includes at least one display-equipped user manipulable input and more particularly to methods of defining, implementing and associating one or more images with one or more such display-equipped user manipulable inputs.

### BACKGROUND

Human input devices are commonly used to enable a user to affect operation of an apparatus that typically is equipped with a processor, storage, and a source or supply of electrical power. Such input devices include text input devices, pointing devices, gaming devices, imaging input devices, video input devices, audio input devices, and the like. Examples of text input devices include keyboards, keypads and the like. Examples of pointing devices include a mouse, trackball or roller ball, pointing stick, joystick, touchpad, graphics tablet, and the like. Examples of gaming devices include a game console, e.g., game pad or joy pad, paddle, joystick, keyboard, remote, and the like. Examples of image and video input devices include a scanner, camera, video recorder, web cam, and the like. Examples of audio input devices include a microphone, recorder, and the like.

Despite the rather abundant variety of input devices that exist today, entry and manipulation of data is still rather cumbersome, relatively slow, and inefficient. Oftentimes the biggest limitation relates to the complexity of the device or software with which the user must interact. While more efficient ways of using the device or software exist, it often takes a great deal of time, in some instances training, for the user to become more proficient. Unfortunately, even where this occurs, the user is often just scratching the surface of how to use the device or software most efficiently.

Quite often, there are tips, tricks, and shortcuts available that can save a great deal of time and effort. Unfortunately, because of the inherent complexity of these devices and software, the task of memorizing them is often impossible if not unmanageable. A prominent example of such software is Microsoft Word, one of the most commonly used software applications in the world. Because it has over 900 shortcuts using key combinations and macros, it is no wonder that the typical user struggles just to achieve a basic level of proficiency. Over time, a typical user may end up memorizing, at the very most, a few dozen shortcuts and macros.

Where on-screen help is available, it can provide useful guidance to the user that can help make use easier, faster and more efficient. However, at some point, productivity gains end up being lost if the user has to resort to calling up onscreen help too frequently. This can also interfere with completing the task at hand, especially where on-screen help ends up obscuring other on-screen data of interest to the user.

What is needed is a way of enabling image and image set configuration and a way of interacting with software applications during operation of a processor equipped apparatus linked to a display input-equipped data entry device that causes images to be displayed one a plurality of display-equipped inputs of the data entry device that execute a task, function or macro that is contextually related to the displayed image. What is also needed is a way of doing so based on a program or software application being executed by the processor-equipped apparatus.

### SUMMARY

The present invention is directed to one or more of a display input-equipped data entry device and method of configuring and operating it. Such a display-equipped data entry device has a plurality of user manipulable display-equipped inputs, such as manually depressible display keys, and is linked to a processor-equipped apparatus such as a computer. Image data is displayed on a display of one or more of the display-equipped inputs that typically provides visually perceptible indicia indicative of a function, task, macro, etc. that is executable when the input is manually engaged.

In one preferred method, the display-input equipped data entry device has a plurality of user manipulable display equipped inputs. A utility executable on a processor equipped device, such as a computer, is used by a user to obtain an image having a first number of pixels that is converted into a second image having a second number of pixels that is lesser than the first number of pixels. Thereafter, the converted image can be shown on a display of the same or different data entry device linked to the same or different process-equipped apparatus.

In one implementation, the first image is converted into a code from which the second image can be derived or otherwise obtained. In one preferred implementation, the code is a hexadecimal code or string of hexadecimal characters that have at least one character for each pixel of the second image when it is converted into the second image.

One or more such codes can be embedded into a document from which a web page can be generated. In a preferred method implementation, the web page can be scanned, such as when it is being viewed in a browser, and read from the web page such that the code is downloaded onto the processor-equipped apparatus upon which the browser is running. The code is convertible to the second image that can then be displayed on a display of a display-equipped image of a display input equipped data entry device linked to the processor equipped apparatus. In a preferred implementation, at least scanning and downloading is performed by a browser module or plug-in of the browser that scans each web page being viewed by the browser and downloads any image codes embedded in the web page.

Such an image code can be embedded in document from which a web page document can be generated by simply inserting it into the web page document. This can be done during creation or editing of the web page document or automatically via a utility configured for image code insertion. In one preferred implementation, each image code is inserted into the web page document, such as in the form of a comment or the like, that prevents the code or any image corresponding to the code to be displayed by the web browser when browsing the web page corresponding to the web page document.

In addition, sets of images, including using such image codes, can be assembled using a layout configuration utility into a layout configuration assignable to a particular program, including a particular key combination that can be pressed during operation of the program. An image or image code is assignable to a particular input using a software utility by dragging it onto an icon representative of that input displayed onscreen on a computer. An existing image, such as from an image file, is convertible using a conversion utility into an image code used to produce a reduced-pixel input display-compatible image. Such codes can be incorporated into HTML, XHTML, XML or other web page code such that a computer running a browser equipped with a code scanning module or plug-in reads each code embedded in a web page being viewed causing the associated image to be displayed on a display of an input of a data entry device linked to the computer.

Various features and advantages of the present invention will also be made apparent from the following detailed description and the drawings.

### DRAWING DESCRIPTION

Preferred exemplary embodiments of the invention are illustrated in the accompanying drawings in which like reference numerals represent like parts throughout and in which:

FIG. 1 is a perspective view of a display-input equipped data entry device connected to a computer;

FIG. 2 is top plan view of the display-input equipped data entry device of FIG. 1;

FIG. 3 is an enlarged fragmentary perspective view of a portion of a display-input equipped data entry device with an image displayed on each display key of the device;

FIG. 4 is an enlarged fragmentary perspective view of a display-equipped input with a text message displayed on its input display;

FIG. 5 is a top plan view of another display-equipped input displaying advertising or promotion related imagery;

FIG. 6 is a cross sectional elevation view of a preferred embodiment of a display-equipped input assembly;

FIG. 7 is a schematic of a preferred display-equipped data entry device controller arrangement;

FIG. 8 is a screen shot of a window depicting a key display image editing and layout software utility;

FIG. 9 is a second screen shot of a window of the image editing and layout software utility of FIG. 8 with an image gallery pane shown;

FIG. 10 is a third screen shot of a window of the image editing and layout software utility of FIG. 8 with the gallery pane hidden;

FIG. 11 is a fourth screen shot of a window of the image editing and layout software utility of FIG. 8 with a new application folder window partially superimposed over the window;

FIG. 12 is a screen shot of a window depicting an image converting utility;

FIG. 13 is a second screen shot of the window of FIG. 12 depicting one step of operation of the image converting utility;

FIG. 14 is a third screen shot of the window of FIG. 12 depicting a further step of operation of the image converting utility;

FIG. 15 is a fourth screen shot of the window of FIG. 12 illustrating an additional step of operation of the image converting utility;

FIG. 16 is a fifth screen shot of the window of FIG. 12 further illustrating an additional step of operation of the image converting utility;

FIG. 17 is a screen capture of a web page displayed in a browser window that has display-equipped input image data embedded in it; and

FIG. 18 illustrates a portion of the web page coding for the web page shown in FIG. 17 showing the embedded display-equipped input image data for a plurality of display-equipped inputs.

Before explaining one or more embodiments of the invention depicted by the above-identified drawings in detail, it is to be understood that the invention is not limited in its application to the details of construction and the arrangement of the components set forth in the following description or illustrated in the drawings. The invention is capable of other embodiments or being practiced or carried out in various ways. Also, it is to be understood that the phraseology and terminology employed herein is for the purpose of description and should not be regarded as limiting.

### DETAILED DESCRIPTION

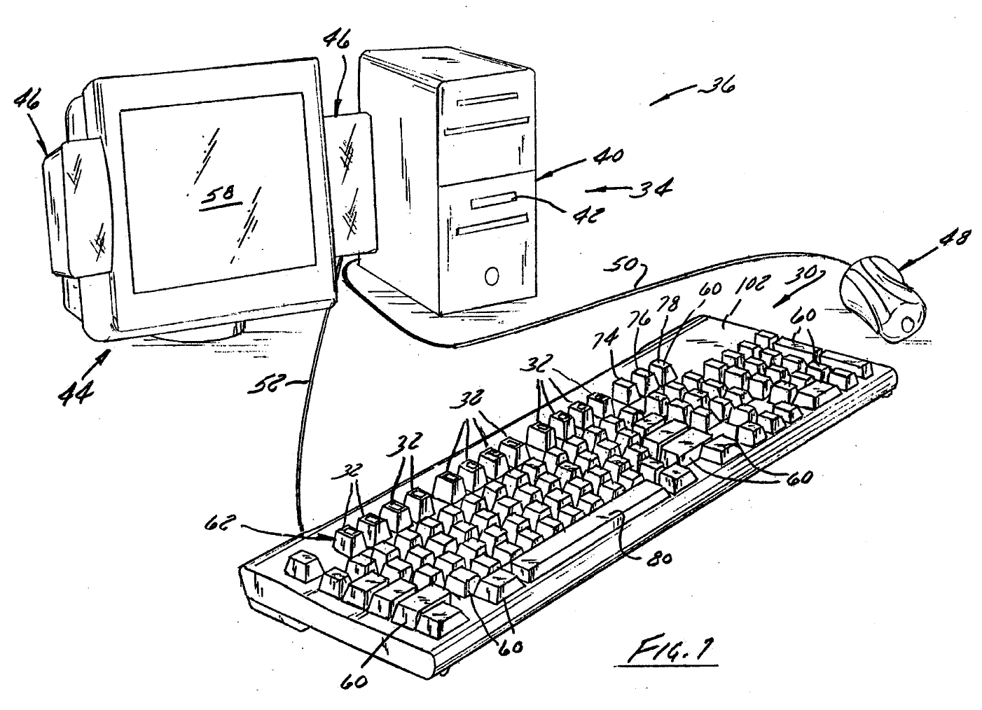

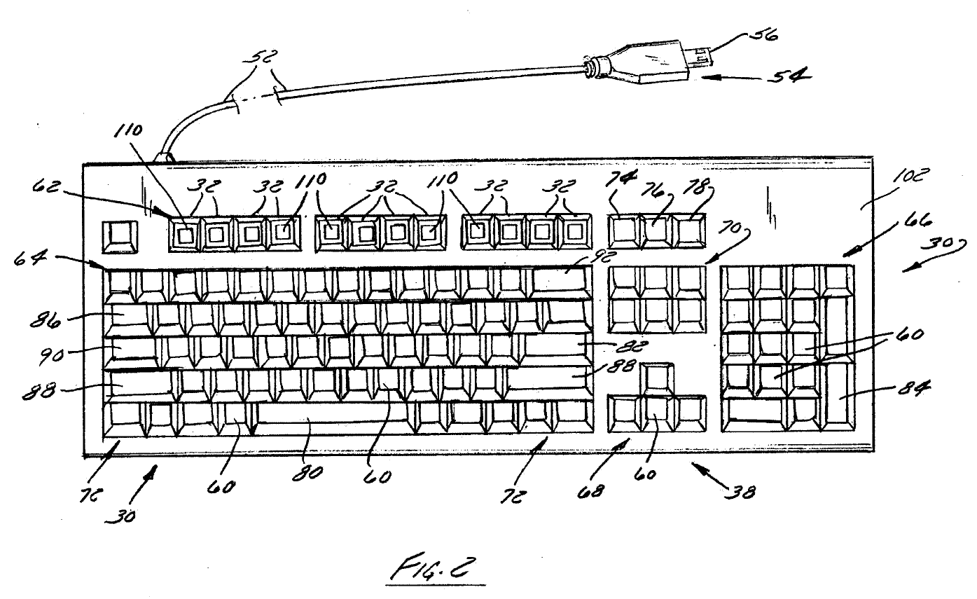

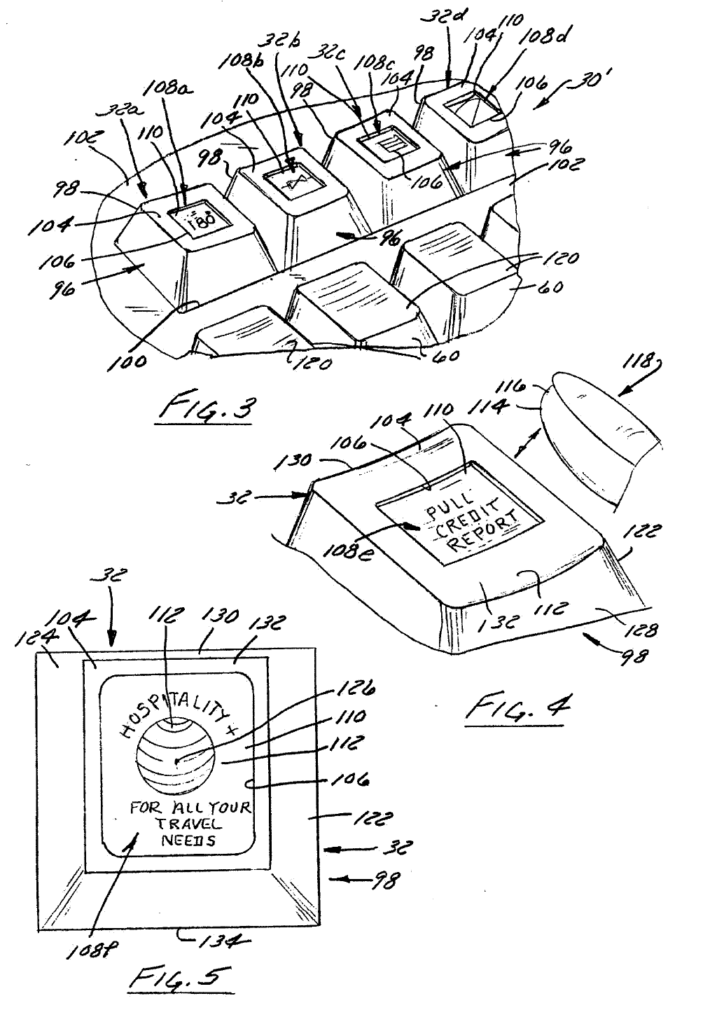

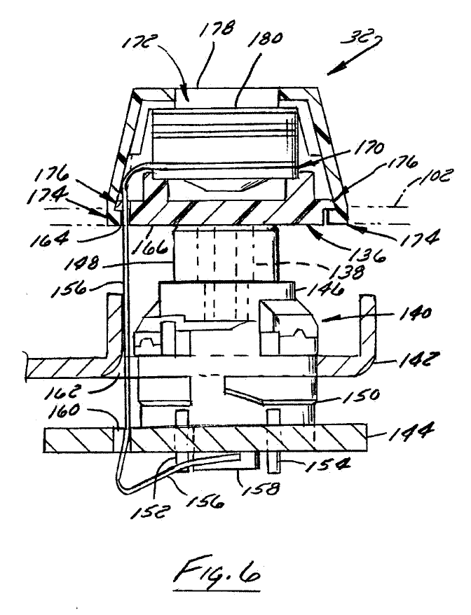

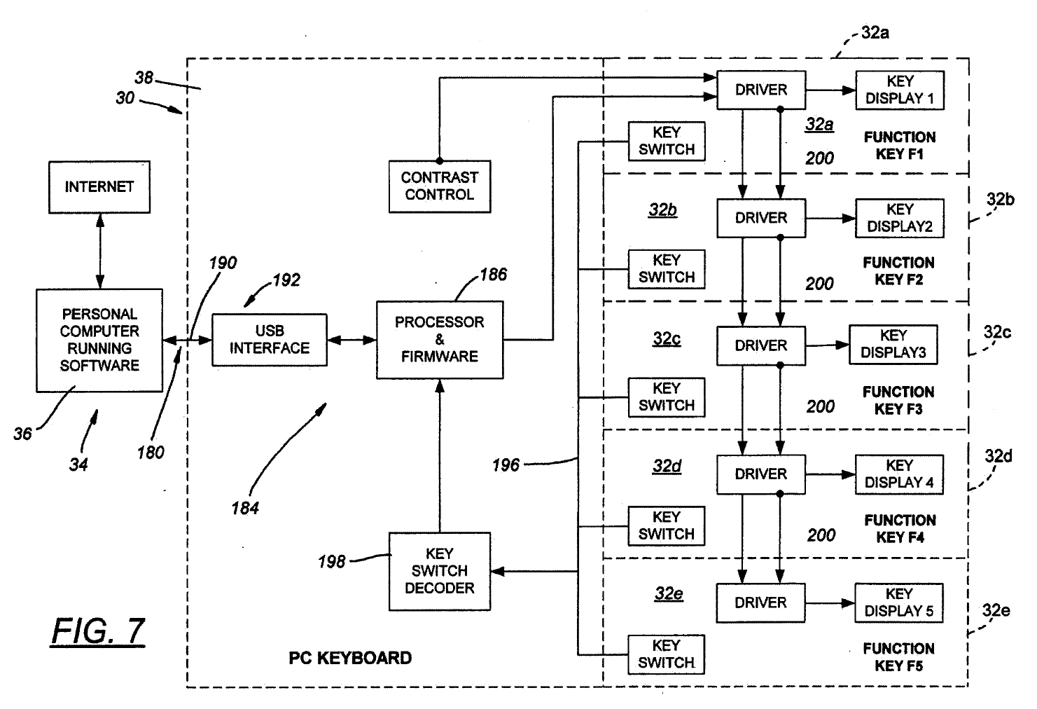

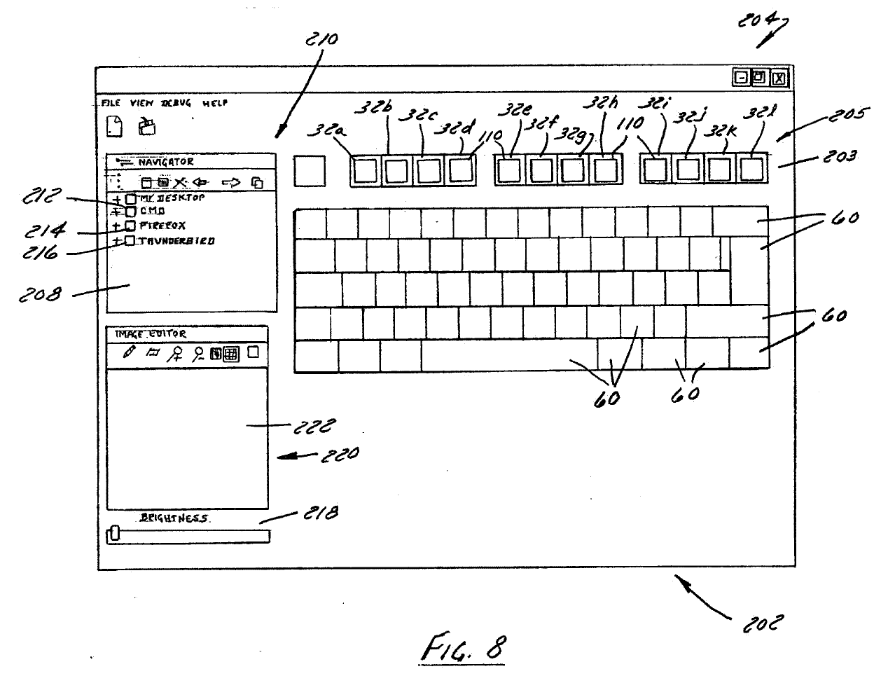

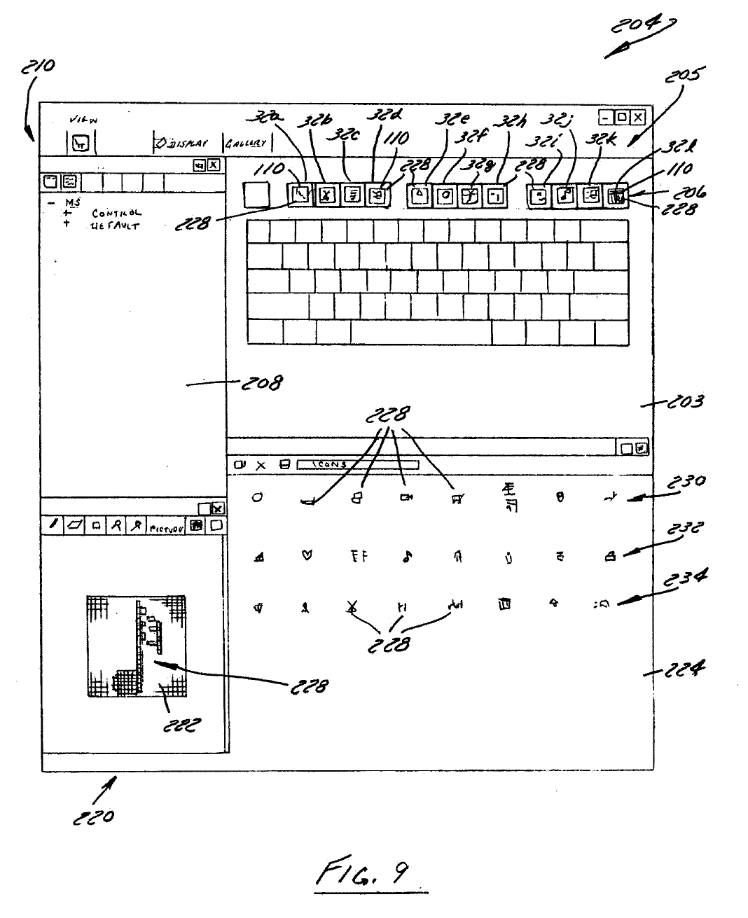

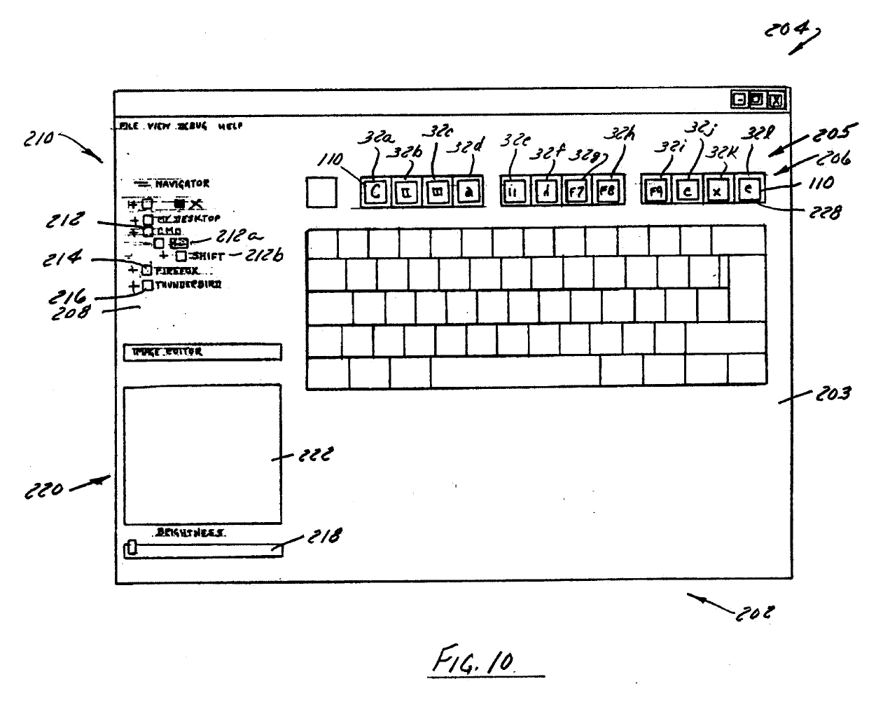

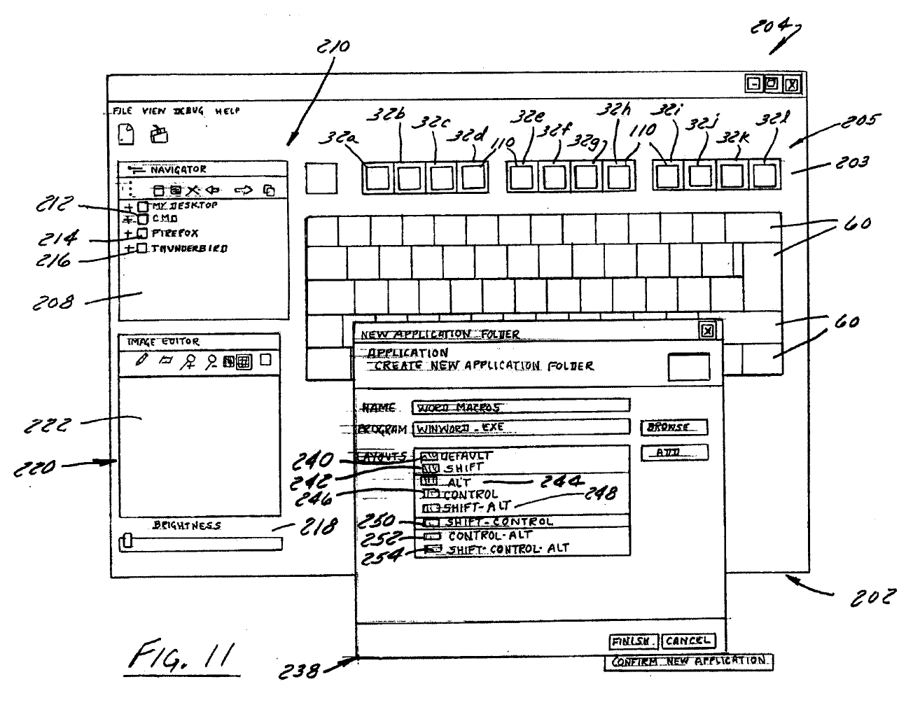

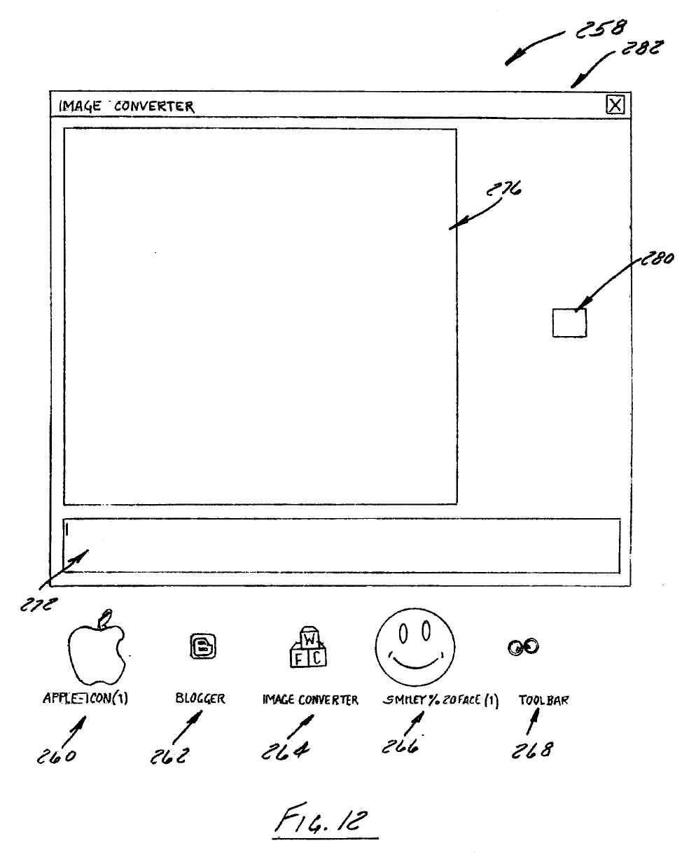

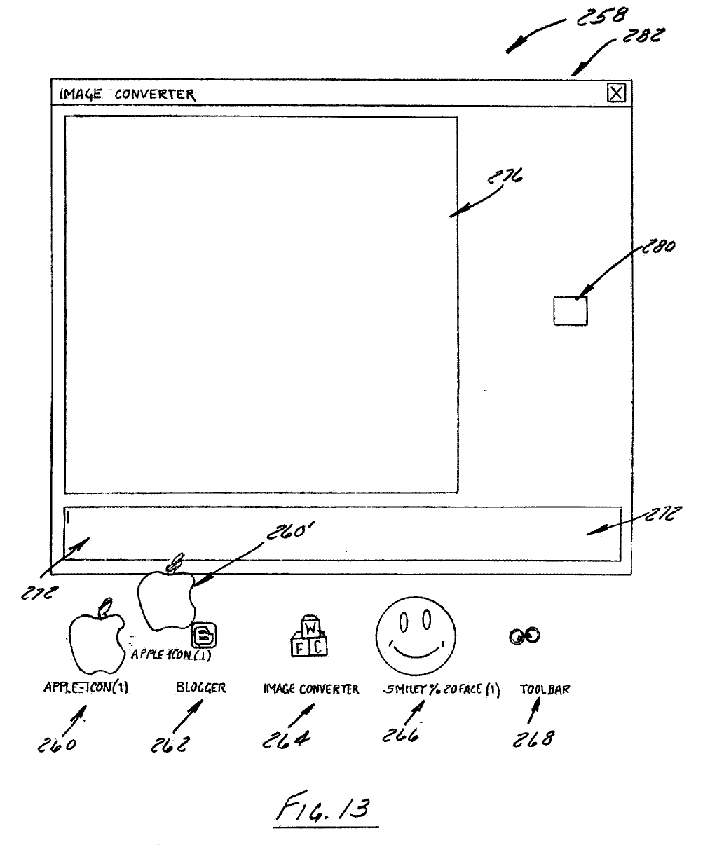

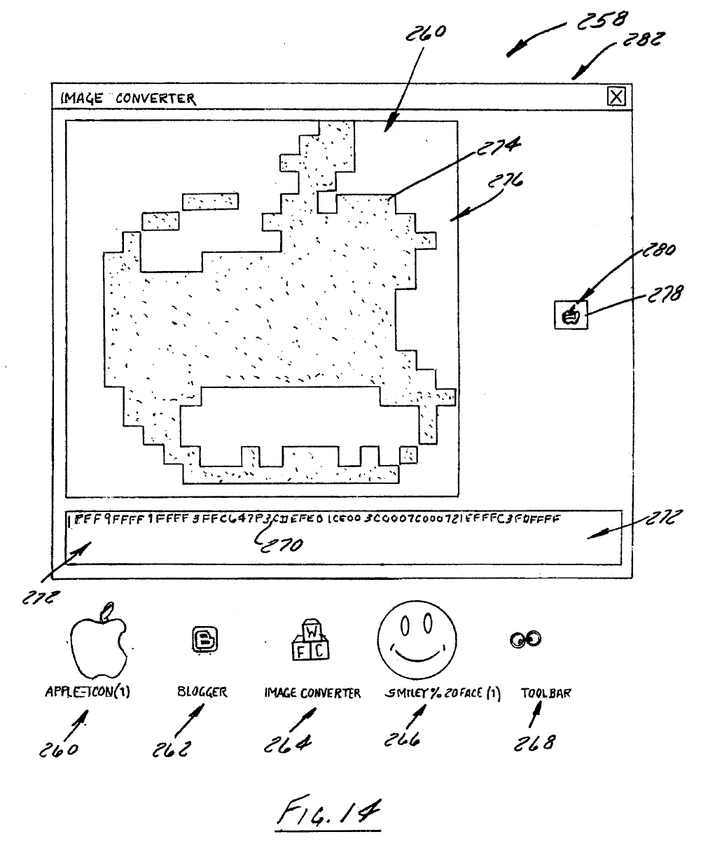

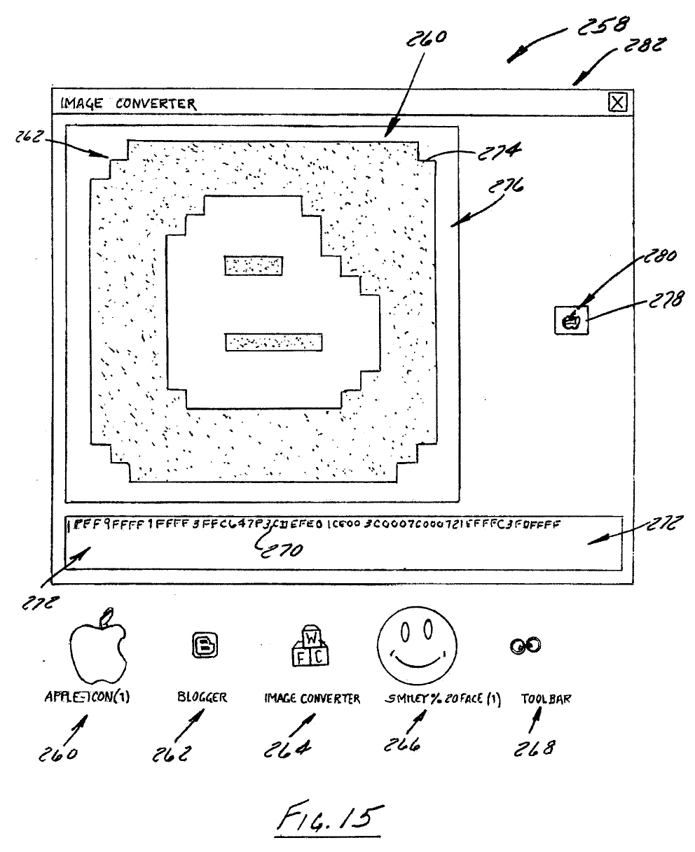

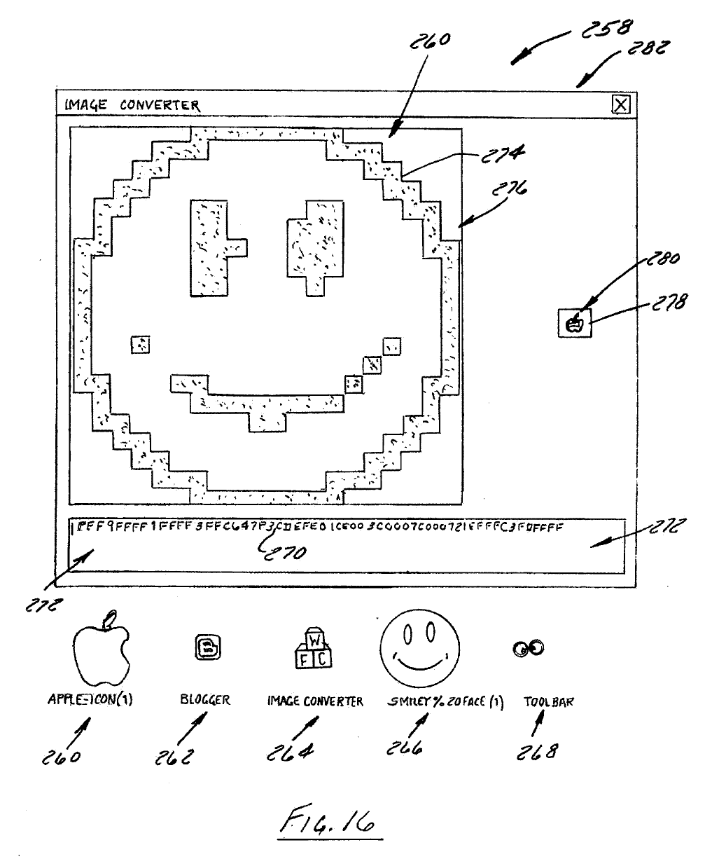

FIGS. 1 and 2 illustrate a preferred embodiment of a manipulable display-input equipped data entry or data input device 30 that is equipped with a plurality of pairs (e.g., three or more) of display-equipped data entry keys 32, hereinafter referred to as display keys, which is linked to a data processing apparatus 34, such as a personal computer 36 or the like. The data entry device 30 depicted in FIGS. 1 and 2 is a display key equipped keyboard 38, hereinafter referred to as a display keyboard, which preferably is a computer keyboard for a personal computer 36 or the like.

As is also shown in FIG. 1, the computer 36 has a case 40, such as a tower, which houses a power supply (not shown), a motherboard (not shown), a processor (not shown), e.g., at least one microprocessor, one or more memory storage units (not shown), such as random access memory (not shown), a disk drive 42, a hard drive (not shown), and the like, a video processor (not shown), a sound processor (not shown), and/or other components. To display information, graphics and the like to a user of the computer 36, a computer monitor 44, such as a CRT equipped with a display screen 58 or an LCD monitor (not shown), is linked by a video cable to a video output carried by the computer case 40. To enable sound output, a set of speakers 46 can be linked by another cable to an audio output that is also carried by the computer case 40.

Additional data entry or data input devices can be linked to the personal computer 36. For example, as is shown in FIG. 1, a mouse 48 can be linked by a cable 50 or the like to receptacle or socket of the computer 36. While a cable 50 is used to connect the mouse 48 to the computer 36, the mouse 48 can also be wirelessly linked to the computer 36 if desired. Although not shown in the drawings, other data entry or data input devices, such as a track ball, game console, joystick, touch sensitive tablet, touch pad, or the like, can also be connected to the computer 36 if desired.

If desired, each one of these data entry or data input devices are human interface devices that can be equipped with display-equipped keys or buttons constructed and arranged in accordance with the display-equipped data entry keys 32 of the display keyboard 38. For example, buttons on-board the mouse 48 can be display-equipped if desired. The same is true of buttons or keys onboard a track ball, game console, joystick, touch sensitive tablet, touch pad, or the like. In the case of a touch sensitive tablet or touch pad, the touch sensitive area of the tablet or pad can be equipped with a display (not shown) that is integrated into the device so as to underlie or be part of the touch sensitive area.

The display keyboard 38 is linked by a cable 52 to the computer 36. As is shown in FIG. 2, the cable 52 has a connector 54 at its free end that is releasably receivable in a socket or receptacle carried by the computer case 40. In a preferred embodiment, the connector 54 used to link the display keyboard 38 to the computer 36 is a USB type A male connector plug 56. While a cable 52 is used to connect the display keyboard 38 to the computer 36, the display keyboard 38 can also be wirelessly linked to the computer 36 if desired. In a preferred embodiment, linking the display keyboard 38 to the computer 36 establishes a high-speed bidirectional digital data link between the display keyboard 38 and computer 36 that enables data transfer at a data transfer rate of at least 12 MB/s such that where a USB serial link is employed it preferably at least complies with USB specification 1.1 or higher.

In a presently preferred display keyboard embodiment depicted in FIGS. 1 and 2, the display keyboard 38 is equipped with at least a plurality of pairs of display keys 32 and at least a plurality of pairs of keys 60 that are not equipped with any display. In the preferred embodiment of the display keyboard 38 shown in FIGS. 1 and 2, the display keyboard 38 has at least a plurality of display keys 32 disposed in a row or column, a plurality of pairs of rows of keys and a plurality of pairs of columns of keys, which can be somewhat staggered such as where the display keyboard 38 implements a QWERTY style layout. While a display key 32 and display keyboard 38 in accordance with the invention is well suited for use with QUWERTY style keyboard layouts, such display keys 32 and display keyboard 38 can also be configured with different layouts, such as the Dvorak layout, MACINTOSH, etc., if desired.

With specific reference to FIG. 2, the display keyboard 38 includes a set of changeable function keys 62 along the top, each of which is a display key 32 according to the invention such that each function key is dynamically reconfigurable in use and operation. Each such display-equipped function key can be user changeable, computer changeable, network changeable or even Internet changeable, depending on the configuration of the processing device 34 to which the display keyboard 38 is linked as well as the configuration of the display keyboard 38 itself. In a preferred embodiment, including as discussed in more detail below, one or more display-equipped function keys are user changeable, e.g., image and/or function programmable, computer changeable, e.g., image and function changeable and/or programmable, network changeable, e.g., image and/or function changeable and programmable, and/or even Internet changeable, e.g., image and function changeable and/or programmable, depending on the configuration of the processing device 34 to which the display keyboard 38 is linked as well as the configuration of the display keyboard 38 itself.

The display keyboard 38 also has a set of alphanumeric keys 64 just below the function keys 62, can have a set of keys to one side that defines a keypad 66, can be equipped with a set of cursor movement keys 68 along with a set of editing keys 70 both of which are located between the alphanumeric keys 64 and the keypad 66, and includes a set of advanced computer operation control keys 72. Particularly where configured for a personal computer 36 or the like, the display keyboard 38 is shown equipped with at least one spacebar 80, at least one Return key 82 and/or Enter key 84, at least one Tab key 86, at least one Shift key 88, at least one Caps Lock or Shift Lock key 90, and at least one Backspace key 92.

A set of dynamically reconfigurable function display keys 62 includes at least a plurality of pairs of display keys 32. In a preferred embodiment where the keyboard is a display keyboard 38 for a personal computer or the like, at least ten Function keys are display keys 32 and the display keyboard 38 can have as many as fifteen such display keys 32, such as where the display keyboard 38 is intended for use with a MACINTOSH computer. For example, where a display keyboard 38 of the type shown in FIG. 2 is configured for an APPLE or MACINTOSH personal computer, the rightmost three keys 74, 76 and 78 located in the same row as the rest of the function keys 62 can also be display keys 32 (not shown in FIGS. 1 or 2).

In a currently preferred embodiment, a display keyboard 38 constructed in accordance with the invention is configured for an IBM-type personal computer 36 and has twelve Function keys that are each dynamically reconfigurable display keys 32. The three non-display keys 74, 76 and 78 to the right of the row of function keys 62 respectively can be a Print Screen/SysRq key 74, a Scroll Lock key 76, and a Pause/Break key 78.

The set of alphanumeric keys 64 includes at least a plurality of pairs of number keys and at least a plurality of pairs of letter keys. While the present invention contemplates a display keyboard where each alphanumeric key can be of dynamically reconfigurable display key construction, the presently preferred display keyboard embodiment depicted in FIGS. 1 and 2 has no dynamically reconfigurable display keys located where the alphanumeric keys are normally located. It should also be noted that a display keyboard constructed in accordance with the invention is well suited for use with keyboards of any language, including English, Chinese, Japanese, Russian (Cyrillic), Turkish, Arabic, and other languages with or without being equipped with display keys 32 as dynamically reconfigurable alphanumeric and/or language changeable keys.

Where equipped with a keypad, the keypad 66 preferably includes number keys ranging from 0-9 along with /, *, −, + and Enter keys with the number keys capable of changing their function to that of one of the cursor movement keys 68 or editing keys 70. The set of cursor movement keys 68 can include an arrow key for each of the four basic directions of cursor movement. The set of editing keys 70 can include an Insert key, a Home key, a Page Up key, a Delete key, an End key and a Page Down key. The set of advanced computer operation keys includes a Crtl key, a WINDOWS or APPLE key, an Alt key, menu activation key(s), along with perhaps a few other keys the function or purpose of which can depend on the type of computer for which the display keyboard 38 is intended, the key layout, and other factors. Of course, as with the non-display keys 60 below the row of display equipped function keys, any of the keypad keys 66 can be display equipped, if desired.

FIGS. 3-5 illustrate use and operation of another display key equipped input device 30′, e.g., a digital data entry device, which is equipped with a plurality of display keys 32 constructed in accordance with the present invention. As is shown in FIG. 3, the input device 30′ can also be equipped with a plurality of pairs of non-display keys of a configuration similar to or same as the non-display personal computer keyboard keys 60 illustrated in FIGS. 1 and 2.

Each display key 32 has an outer housing 96, at least part of which defines a display keycap 98 that projects upwardly from a slot or channel 100 formed in a housing 102 of the input device 30′. The display keycap 98 of each display key 32 has a top surface or wall 104 that includes a generally centrally located window or aperture 106 that is transparent enough that a user of the input device can view an image 108a-108f shown on a display 110 located inside the display keycap 98. As is shown more clearly in FIG. 4, the top wall 104 of the display keycap 98 has a curvilinear concave contour 112 so as to better conform to the convex curved outer surface 114 of a tip 116 of a finger 118 of a user (not shown) pressing the display key 32 with the display keycap top wall 104 being configured to have a concave exterior surface shape that is substantially the same as the concave exterior contoured outer surface 120 of at least a plurality of adjacent non-display keys 60 (FIG. 3).

As is shown in more detail in FIG. 5, the display keycap housing 96 of each display key 32 has a pair of spaced apart sidewalls 122 and 124 extending along a longitudinal direction relative to the key 32 with both sidewalls 122 and 124 being inclined so as to converge generally toward one another at an acute angle relative to a central axis of displacement 126 of the display keycap 98 along which the display keycap 98 generally travels when displaced when the display keycap 98 is pressed down by a user (not shown). This central key displacement axis 126 is shown in FIG. 5 as a small round dot that represents an imaginary axis that extends perpendicular to the outer surface of the display keycap window 106 or key display 110. In a preferred embodiment, each display keycap sidewall 122 and 124 is inclined at an acute angle of no greater 30° relative to the central key displacement axis 126 and at an angle no greater than about 20° relative to the axis 126.

The display keycap housing 96 also has a front wall 128 and a rear wall 130 with at least one of the front wall 128 and rear wall 130 having a similar magnitude of angular inclination relative to the central key displacement axis 126 as the sidewalls 122 and 124. Both display keycap housing walls 128 and 130 are generally perpendicularly oriented relative to the sidewalls 122 and 124. In the preferred display key embodiment shown in FIG. 5, the front wall 128 of the display keycap housing 96 generally will be the wall 128 of the display keycap housing 96 situated closest to a user (not shown) pressing down on the corresponding display key 32. In this same preferred embodiment, the front wall 128 is shown inwardly inclined toward the rear wall 130 such that it has an angle of inclination relative to axis 126 that preferably is no greater than 30°. Preferably, the angle is no greater than about 20°. In a preferred embodiment, both sidewalls 122 and 124 preferably are acutely angled relative to the central key displacement axis 126 at substantially the same angle with their angles of inclination preferably deviating from being the same by no more than 5°. The same preferably is also true with regard to the front wall 128. To the extent the rear wall 130 is inclined at all toward the front wall 128; it preferably is inclined no more than 10° and preferably not more than about 5° relative to the axis 126.

The display keycap 98 is shown in FIGS. 3-5 as having relatively optically opaque walls 122, 124, 128 and 130 along with a relatively opaque inwardly turned lip 132 of the display keycap top wall 104 that defines the periphery of the display keycap window or aperture 106. The lip 132 of the display keycap 32 is narrower in FIG. 5 than in FIG. 4 for increasing window surface are which in turn increases the surface area of the display 110 that is viewable by a user. Such an opaque display keycap design can advantageously be made of an economical synthetic material that is lightweight, tough and yet crack resistant. One preferred material from which a display keycap in accordance with the present invention can be molded is plastic, such as ABS, polystyrene or another suitable plastic. Where the window 106 is defined by an absence of material, such a display keycap 98 in accordance with the invention can be molded such that the window 106 is created substantially simultaneously during molding. Where the window 106 is made of a translucent or transparent material and the rest of the display keycap made of an opaque material, a molding process that accommodates molding the window in place during molding of the display keycap 98.

In another preferred embodiment, the display keycap 98 is made of a translucent material that can be substantially clear or transparent. Examples of suitable plastics from which such a display keycap can be molded include polycarbonate, styrene, and acrylic materials. Where the display keycap 98 is made of such a see-through material, the window or aperture 106 can be eliminated or molded with the rest of the display keycap 98 if transparent enough. Where constructed in this manner, a display 110 having a larger viewable surface area that is substantially the same as the surface area of the display keycap top wall 104 can be used which advantageously increases displayed image, character, icon and symbol size thereby improving display readability.

As a result, a display key 32 constructed in accordance with the invention can be made economically and durably while still being able to be made small enough to be substituted for conventional personal computer keyboard non-display keys. For example, where configured for personal computer keyboard use, a display key 32 constructed in accordance with the invention preferably has a height and width no less than 16 millimeters (about 0.63 inch) and no greater than 19 millimeters (about 0.75 inch). Since at least the sidewalls 122 and 124 as well as preferably the front wall and/or the rear wall taper inwardly toward each other as they extend upwardly from the bottom 134 (FIG. 5) of the display keycap 98, the display keycap top wall 104 is smaller in size than its bottom 134.

In a preferred embodiment, such as is depicted in FIG. 1, each one of the display keys 32 is of substantially the same size as adjacent alphanumeric non-display keys 60. In a preferred embodiment, the window 106 in the display keycap top wall 104 and/or the display 110 of the preferred embodiment depicted in FIG. 5 has a height no greater than about 12.87 mm (about 0.50 inch) and a width no greater than about 10.87 mm (about 0.43 inch). In another preferred embodiment, the height is at least 6 mm (about 0.24 inch) and no greater than 14 mm (about 0.55 inch) and a width of at least 6 mm (about 0.24 inch) and no greater than 12 mm (about 0.47 inch). For example, the window/display can have a height of about 6 mm (about 0.24 inch) and a width of about 8 mm (about 0.31 inch) within a range of ±1 mm (about 39 mils). Such a novel display key construction advantageously enables it to be used with little or no mechanical design modification of existing conventional personal computer keyboards, including those of conventional and small form factors. In addition, such a novel display key construction also enables its use in notebook computer keyboards where rather stringent and tight packaging constraints exist.

As a result, a display key 32 constructed in accordance with the invention requires little to no training because of its intuitive and easy to grasp reconfigurable key display interface that helps facilitate more efficient input device use. This also translates into increased worker productivity, reduced training time and costs, as well as more efficient data processing device use. For example, a display keyboard or display keypad employing display keys constructed in accordance with the present invention is well suited not just for computer and game console gaming applications, it is also well suited for use in call centers, manufacturing and process control rooms and monitoring applications, as well as for advertising and client reward programs.

Where used in call centers, such display keyboards in combination with computer workstations can be used to help more efficiently, quickly and seamlessly enable a customer service assistant to serve many more clients than at present. For example, workstation software can quickly and seamlessly change the images being displayed on the display keys based on the customer and phone number as well as based on the client for whom the call is being handled. Given the rapid and increasingly widespread adoption of IP telephony, such software can be executed on personal computers, IP telephones and/or the IP telephony system, e.g. PBX, to help provide a more productive and advantageous calling experience for the IP telephony user.

For example, where the processing device 34, e.g., computer or the like, is configured for telemarketing or another type of call center task, a call coming in or being made related to a prospective mortgagor or mortgage refinance candidate causes software or firmware to be executed, such as by the processing device 34, that causes the display of at least a plurality of the display keys to show a corresponding plurality of related tasks or options available to the customer service assistant, e.g., telemarketer, based on how the call is going. In this regard, if the call made or received is for or relates to a prospective mortgagor or mortgage refinance candidate, the processing device 34 is configured to cause the image 108e, “Pull Credit Report” to be shown on the display 110 of display key 32 shown in FIG. 4 enabling the customer service specialist to call up the credit report of the caller via execution of a software script or the like that transmits the pertinent caller data, e.g., name, social security number, address, etc. to an online credit report service that makes third party credit reports available to a subscriber over the Internet for a fee.

Thereafter, based on the nature of the very next call made or received, the display 110 of this display key 32 along with at least a plurality of other display keys 32 changes to show selections that correspond to the call being made or received. For example, where the next call made or received after the mortgage or refinance related call discussed above is completed; the next call is to or from a person whose business is completely unrelated to that of the previous call. In this regard, where such a call relates to a loan servicing client, the person whose loan is being serviced by that client that is the object of the telephone call automatically causes a list of options or tasks that can be carried out on at least a plurality and preferably each display of each display key 32. For example, where one of the options displayed on one of the display keys 32 recites “Retrieve Payment History,” (not shown) pressing this display key automatically executes a software script, subroutine, or program that retrieves the payment history of the caller so the customer service representative on the phone with the caller can more quickly, efficiently and accurately help the caller.

Such a display keyboard can also be of benefit for everyday computer users. For example, in one preferred method of operation, a program, such as an API or Active X control run on the personal computer of a computer user browsing the Internet screening module or filter the current web page for corresponding code that invokes a change of the displays of one or more of the display keys 32 of the browsing computer. In addition, key display image data is also downloadable from the web page or a different web page once the screening module or filter detects a flag, e.g. certain code or the like, embedded in the currently browsed web page for being read and then shown on a display of a display key 32.

For example, as a person browsing the Internet using a computer 36 equipped with a display keyboard 38 browses a web page of a website that is embedded with display keyboard affecting code, such as XML, HTML, PERL, Active X, or the like, software such as in the form of a thread of a script, software module, subroutine, program, API or the like, detects the display keyboard affecting code and either executes it or carries out a series of steps based on the code. In this regard, the resultant execution causes the display 110 of at least one display key 32 to display an image or change the displayed image to one based on the embedded display keyboard affecting code. For example, as is shown in FIG. 5, where the embedded web page display keyboard affecting code is advertising related, it causes the logo, name, and/or advertising slogan(s) to be displayed as an image 108f on the display 110 of at least one of the display keys 32 of the display keyboard 38 that is linked to the computer 36 connected to that web page. Thereafter, should the person press this display key 32, it will carry out a task that relates to the business of the company associated with the displayed logo, name and/or advertising slogan(s). In one preferred implementation of such a method, pressing the corresponding display key 32 causes the browser to redirect to the website of the company associated with the displayed logo, name, and/or advertising slogan image 108f. Revenue can be derived based on how many different computers equipped with a display keyboard 38 execute the embedded web page code of a web page document and cause a display key 32 to change its image to that of the desired advertising or promotional image 108f as well as how many times an actual user actually presses or otherwise engages the display key 32 showing the corresponding advertising or promotional image 108f.

In like manner, software, such as a thread or the like, operating on a computer equipped with such a display keyboard 38 can remotely connect with a remotely located computer, such as a server or other computer with which it connects via a network, such as the Internet or the like, to obtain one or more images to be displayed on display keys 32 depending on whether it is subscription based, advertising based, web content based or based on another revenue generating business model. For example, purchasers of a new computer equipped with a display keyboard will benefit from pre-installed software that loads and displays images on the display keys 32 that relate to quickly obtaining customer assistance, such as by directing the purchaser to a customer support website when the corresponding “customer support” related labeled display key 32 is pressed, a site for downloading useful software to which the purchaser will be directed when the display key 32 showing a related message, logo or image is displayed, running a particular program, such as a program which automatically performs a self-diagnostic routine on the computer once the display key 32 displaying a related “run diagnostics” image (not shown) is pressed. Other functions, tasks and options can also be implemented in like manner.

A display keyboard equipped data processing device can also benefit from implementing a method of the invention where process, assembly line, logistical status, financial, production or other type of business related information or data is being monitored on an ongoing basis, including in real time, whether the display keyboard equipped processing device 34, e.g., data processing device, is located onsite or remotely such that the desired data being monitored is delivered to the device 34 over a network or the like. FIG. 3 illustrates display keys 32a-32d each showing a different image that relates to a different type of data or information being provided to it from the plant, office, or other data or other information source. For example, the display 110 of display key 32a is depicted as displaying a temperature or angle related image, e.g. “180°” that a person monitoring can immediately press the display key 32a to carry out some action should circumstances dictate. For example, where a threshold or threshold range is exceeded or not met, the color of the displayed image 108a related to temperature or angle data received by the processing device 34 can change and/or it can begin flashing to get the attention of the monitoring person.

Similarly, display key image 108b shown on display key 32b is representative of the status of a device being monitored, which for the purposes of this example is a valve as indicated by the valve schematic image 108b shown. The image can change, e.g., animate as needed to show changes in the status of the device being monitored. For example, where the valve needs to be adjusted, closed or opened, something like that previously mentioned can be carried out to make the image get the attention of the monitoring person. As is discussed in more detail herein, one preferred embodiment of a display key constructed in accordance with the invention includes a transducer, including one capable of emitting audible sound, such that the particular display key 32b can also be activated to cause it to emit a sound alone or in addition to changing brightness, color or image flashing in order to try and get the attention of the monitoring person.

Similar image delivery, monitoring and task execution methods are implemented with regard to the dynamic bar graph image 108c shown on the display 110 of display key 32c as well as for the dynamically changeable meter image 108d shown on the display of display key 32d.

FIG. 6 illustrates a preferred embodiment where the key switch assembly 140 is anchored to an internally disposed keyboard frame 142 that is separate from the keyboard controller circuit board 144 and housing 102. In some instances, it is recognized that it can be mounted to the circuit board 144 and keyboard housing 102, particularly where the keyboard lacks a separate frame of the type depicted in FIG. 6.

As is shown in phantom in FIG. 6, the plunger 138 of the display key 32 is reciprocably received in a complementary socket or receptacle (not shown) formed in the key switch assembly 140. The key switch assembly 140 has an outer housing 146 that is mounted by physical attachment to the internal keyboard frame 142. The plunger accepting socket is disposed in an upwardly extending pedestal 148 of the housing 146. The key switch housing 146 can be physically mounted using one or more fasteners, such as rivets, screws, bolts or the like, or can use another means of attachment.

A bottom section 150 of the key switch housing 146 is mounted to the keyboard circuit board 144 by soldering or otherwise electrically attaching to the circuit board a plurality of switch contacts 152 and 154 that extend from the key switch housing 146. Each key switch contact 152 and 154 help define a switch circuit that is closed when the display key 32 is pressed downwardly a sufficient distance until its plunger 138 bears against a part of a switch arrangement disposed within the key switch housing 146 actuating the switch of the switch arrangement.

Examples of exemplary and suitable switch arrangements along with exemplary and suitable key switch assemblies are shown and disclosed in aforementioned U.S. Pat. Nos. 6,057,522, 5,386,091, and 4,939,324, the entire disclosures of each of which is incorporated by reference herein. Other key switch arrangements can also be used, which is an advantage of the display key 32 of the present invention in that it can utilize any kind of pre-existing plunger configuration such that it can be easily adapted for use with just about any kind of a key switch assembly, known or otherwise. In this regard, a display key constructed in accordance with the present invention is well suited for use with membrane-type keyboard and keypad key switch arrangements of conventional construction as is known in the art.

As is also depicted in FIG. 6, cable 156 is attached to part of the keyboard circuit board 144 via connector 158. The cable 156 passes through a channel 160 in the circuit board 144, through a passageway 162 formed in the keyboard frame 142, and through a cable conduit 164 integrally formed in the display key base platform 166. The cable 168 connects to the display driver circuit board 170 onboard the display key 32. The display driver circuit board 170 has a display driver on it that is used to drive the key display of the display module 172 of the display key. If desired, it can directly connect to the display module 172, such as where no onboard display driver circuit board 170 is used.

The keycap housing 174 snaps onto and over part of a key base 136 from which the plunger 138 outwardly projects into the key switch socket in the pedestal 148. The housing 174 engages a tab 176 that extends outwardly from at least one side edge of the base 136. The housing 174 includes an outer substantially transparent window 178 through which a display 180 of the display module 172 can be visibly viewed by a user.

The display 180 is physically associated with the manipulable user input device, which in the present invention is a depressible display key 32 configured for PC keyboard use. The display 180 is physically associated by being disposed onboard or integral with the display key 32 and displaying information thereon in the form of an icon, symbol, image, or other visually perceptible indicia that relates to a function, task or macro assigned to the key 32 that is carried out when pressed. Preferred examples of such user manipulable display key embodiments are disclosed in commonly assigned and presently co-pending U.S. application Ser. No. 11/406,948, filed Apr. 18, 2006, the entire disclosure of which is expressly incorporated herein by reference. A display key 32 is user manipulable as it is manually pressed by a user during operation to provide an output signal, data or the like to the processor-equipped apparatus used to help control or otherwise operate the apparatus.

FIG. 7 depicts a schematic diagram of an exemplary but preferred embodiment of a hardware and firmware arrangement of the display keyboard 38 of FIGS. 1 and 2 that includes a controller arrangement 184 constructed, arranged and configured for display keyboard 38 used and operation. At least part of the controller arrangement 184 can be implemented in software or firmware by processor 186 by which sets of image data for a plurality of pairs of display function keys 32a, 32b, 32c, 32d and 32e are communicated from the processor equipped apparatus 34, e.g., computer 36, via a bus 188, such as a USB bus 190 and interface 192 to the processor 186 of the data entry device 30, e.g., display keyboard 38. As is shown in FIG. 7, the USB bus 190 extends internally within the controller arrangement 184, which is disposed within the keyboard 38. One or more sets of key display image data for a plurality of display keys 32a-32e are delivered from the processor equipped apparatus 34 using the USB link 190 and/or interface 192 to the processor 186. The sequence or order of the sets of key display image data can be used to determine which one of the display keys 32a-32e receives which set of image data to control which display key displays which image. It can be predetermined by the order in which a particular set is received by the processor 186 determining which set of image data will be provided to which particular display key 32a-32f.

If desired, additional data can be provided, such as via the processing device 34, which the processor 186 can use to assign each received set of image data to a specific display key 32a-32f. If so, the processor 186 can be configured, such as via firmware, software (not shown), or the like, to slot, order or reorder the received sets of image data so image data sets will be serially delivered in the desired order to the display keys 32a-32f when the processor 186 communicates the image date via the serial bus to the display keys 32a-32e.

While the processor 186 preferably is disposed onboard the data entry device 30, it can be located off-board the device 30 if desired. In one preferred embodiment, the functions carried out by the processor 186 and any firmware used by the processor 186 is performed by a different processor (not shown) where practicable, such as the processor of the processor equipped apparatus 34. Where this is done, the firmware code or instructions are implemented in software that is executed by the processor-equipped apparatus 34.

In a preferred method of operation, a plurality of sets of image data, I₁-I₅, is delivered to the processor 186. The processor 186, once ready to change the images being displayed on display keys 32a-32e, communicates the image data via a serial bus 200 such that set I₅ is slotted first to be delivered on the serial bus 194, I₄ is slotted next, I₃ is slotted after I₄ and so forth. Once the bus 200 is full such that a set of image data for each one of the display keys 32a-32f has been communicated serially on the bus 200 to the display keys, each display key 32a-32f receives the desired image data and thereafter displays the desired image associated with that image data. For example, a first image associated with first in queue image data set I₅ will be delivered first to bus 200 of display key 32e so it is received by its display driver and then displayed by display key 32e, a second image associated with second in queue image data set I₄ will be delivered second to bus 200 so it is received and displayed by display key 32d, a third image associated with first in queue image data set I₃ will be delivered third to bus 200 so it is received and displayed by display key 32c, a fourth image associated with first in queue image data set I₂ will be delivered fourth to bus 200 so it is received and displayed by display key 32b, and a fifth image associated with first in queue image data set I₁ will be delivered last to bus 200 so it is received and displayed by display key 32a.

In a further preferred method of display key use and operation, a display key 32a, 32b, 32c or 32d is pressed; it closes its associated key switch causing a signal to be communicated along a bus 196 to a key switch decoder 198 that can be of conventional construction and configuration. More specifically, a display keyboard constructed in accordance with the invention uses a conventional keyboard key switch decoder and associated circuitry. The key code associated with the particular display key 32a, 32b, 32c, 32d or 32e that was pressed is communicated via bus 194 ultimately to the processing device. In the preferred embodiment shown in FIG. 7, the key code, e.g. ASCII code, corresponding to the pressed display key 32a, 32b, 32c, 32d or 32e is communicated to the processor, which in turn, communicates it to the processing device. The processing device 34 thereafter interprets the received key code and then executes the task or function associated with the code. Where the data entry device 30 is also equipped with non-display keys, the same key switch decoder arrangement is advantageously employed such that only a single key switch decoder 198 handles key switch signals received from display keys and non-display keys.

FIG. 8 illustrates an operating window 202 of a preferred embodiment of an input display image editing and layout utility 204 capable of enabling a user to create, delete, modify, etc. images for display on one or more displays of one or more display-equipped user manipulable inputs of a display input-equipped data entry device used in helping to control a processor equipped apparatus, such as a computer, a cell phone, a dedicated gaming apparatus, a personal digital assistant, a piece of video equipment, a piece of audio equipment, a home theater system, a printer, a scanner, another piece of printing equipment, a piece of reproduction equipment, and/or the like. There is no limit to the type, nature and variety of processor equipped apparatuses with which a method carried out in accordance with the present invention is suited for use.

Each display-equipped user manipulable input, such as display key 32 depicted in FIGS. 1-5, is linked to the processor-equipped apparatus, such as personal computer 36, by a connection, such as a bus or interface, which can be a hard-wired or wireless link or connection. While a particular display input-equipped data entry device 36 can be equipped with only a single user manipulable input 32 having an onboard display 110 that can be directly connected to the processor of the apparatus 36 without any interface or the like, the present invention contemplates use of a data entry device, preferably a human interface device, such as a display keyboard 38 or the like, which is equipped with at least one display-equipped user manipulable input, such as a depressible display-equipped display PC key 32 or the like.

As previously discussed above in regards to FIGS. 1-5, each display 110 of each display-equipped user manipulable input 32 shows during operation an image that is representative of a function, task or macro assigned to the corresponding input 32 that will be carried out when the input 32 is activated through user manipulation, e.g., engagement. For example, where the input is a display key 32, an image is displayable on the display 110 of the display key 32 that is representative of the function, task or macro assigned to that particular key 32 with the image being constructed to provide the user with a mental impression of the nature of the assigned function, task or macro simply by looking at the displayed image during use and operation.

The layout utility 204 displays on a screen, such as a CRT or monitor (not shown in FIG. 8), of a processor-equipped apparatus, e.g., computer 36, a layout pane 203 of a layout builder 205 that includes a currently modifiable layout configuration 206 that is representative of a particular input device that is equipped with one or more display-equipped user manipulable inputs 32a-32l (FIGS. 8 and 11). In the preferred embodiment shown in FIG. 8, the layout configuration 206 is substantially the same as that of the display keyboard 38 depicted in FIGS. 1 and 2 such that the layout configuration 206 shows a corresponding row of display keys 32 (numbered 32a-32l in FIGS. 8 and 11) of the same number of display keys as the display keyboard 38 and the same number of rows of non-display keys 60 each having the same number of non-display keys 60 therein as the display keyboard 38. The layout utility 204 can be implemented so as to be executable on a computer, such as a personal computer or the like, a cell phone, a remote, a gaming device, a gaming console, a PDA, a computer peripheral, or another type of processor-equipped apparatus that includes, is linked to, and/or is linkable to a display screen, such as a CRT, LCD monitor, gas plasma monitor, or the like.

The layout utility 204 also includes a navigator pane 208 for a layout configuration navigator 210 that is capable of holding one or more display key image layout configurations (not shown in FIG. 8), each of which includes an image for every user manipulable input display 110 of each display equipped input 32a-32l with each image of a layout configuration being assigned to a specific display-equipped user manipulable input 32a-32l. As is better shown in FIG. 9, each layout configuration, including the currently modifiable configuration 206 shown on the display-equipped inputs 32a-32l simulated on screen 58 of processor-equipped apparatus 36, is assigned (or assignable) to a particular application of the processor-equipped apparatus for which the display input equipped input device 38 is intended to operate. For example, there is a plurality of pairs of application-specific layout configuration holders 212, 214 and 216 shown in the navigator pane 208 of FIG. 8, each of which has at least one layout configuration (not shown in FIG. 8) associated therewith.

The layout utility 204 also includes an image editing pane 218 for an image editor 220 that is capable of creating, deleting, editing and otherwise modifying an image (not shown in FIG. 8) that is displayable on a display 110 of a display-equipped user manipulable input 32. As is shown in FIG. 9, pixels of the image 228 can be manipulated to create, edit or otherwise modify it. In FIG. 8, all of the input displays 110 have no image such that they are all blank. The image editor 220 is also configured to enable an image to be assigned to a particular display 110 of a particular display-equipped user manipulable input 32. The image editing pane 218 includes a human interface device manipulable pixilated array region 222 that can be manipulated on screen by a user to make or modify an image.

FIG. 9 illustrates another preferred embodiment of a layout utility 204′ that further includes an image gallery pane 224 of an image holder 226 capable of holding a plurality of pairs of images 228, three rows 230, 232 and 234 of which are shown. As is shown in FIG. 9, an image 228 can take the form of an icon, a symbol, a picture or another type of visually perceptible indicia that is capable of being animated when shown on a display 110 of a display-equipped user manipulable input 32. In a preferred implementation, one or more of such images 228 can be capable of animation, such as in the manner of an animated GIF image. If desired, images capable of animation can be individually animated or can be animated substantially in unison, such as where a plurality or a plurality of pairs of images each form part of a larger image or image arrangement.

Each image 228 can be selected, such as using a human interface device (not shown) or the like, and manipulated by a user to transfer it to the pixilated array area 222 of the image editor 220 and/or to one or more of the displays 110 of one or more of the display-equipped user manipulable inputs 32 shown of the currently active layout configuration 206′ shown in the layout pane 203. In a preferred implementation, a mouse can be used to select, drag and drop an image 228 from the gallery pane 224 onto either the pixilated array region 222 of the image editor 220′ or a display 110 of one of the inputs 32 of the currently active layout configuration 206′.

When an image 228 is “dropped” onto the pixilated array region 222 or a display 110 of the currently active layout configuration 206 or 206′, the image 228 thereafter appears in the array region 222 and/or the display 110 because it gets loaded by the corresponding utility as a result. Where “dropped” onto the array region 222, an image 228 can then be edited with the image editor 220 or 220′ by a user. Where “dropped” onto one of the displays 110 of one of the inputs 32, the image 228 becomes thereafter assigned to that particular display 110 of that particular input 32 of the currently layout configuration 206 or 206′ such that it replaces any prior image that was previously shown on the display 110 of that layout configuration. Where an original “dropped” image is larger than the number of pixels of the pixilated array region or the number of pixels of the display 110, the image editor and/or layout builder automatically translate or otherwise re-configure the original image to fit the size of the display 110 to create an image 228 from the original that can be shown on the display 110.

FIG. 10 depicts a further aspect of a method of operation of the layout configuration navigator 210 by showing the cmd.exe application configuration holder 212 in an expanded state illustrating that there are a plurality of pairs of layout configurations 212a and 212b associated with that holder 212. Each of these configurations is stored in a digital data format, such as in a string of hexadecimal characters for each image of each display of a configuration. Each image data string can be configured in a manner where parsing delineates separate image data strings for different images of a layout configuration. In one preferred method implementation, one or more unique characters are inserted between image data strings such as to provide a flag, header, or the like indicating start and/or stop of an image data string.

As is shown in FIG. 10, there is a default “cmd” layout configuration holder 212 from which a “shift” layout configuration 212a is associated. To cause a particular configuration to be displayed on the displays 110 of the inputs 32a-32l of the currently active configuration, a mouse is used to select the configuration by clicking or double clicking on its corresponding “cmd” icon 212a or “shift” icon 212b in the layout configuration navigator pane 208. Each configuration 212a or 212b can have different image data stored for each display 110 of each input 32a-32l for at least a plurality of the display-equipped user manipulable inputs 32.

With additional reference to FIG. 11, in a currently preferred method implementation, a “default” configuration is provided that has a series of predefined images already stored and assigned to the displays 110 of specific inputs 32a-32l. Each application-specific layout configuration holder, e.g., designated by reference numerals 212, 214 and 216, is configurable so as to hold at least a plurality of layout configurations that are each context, event, and/or manipulable user input dependent. For example, in one preferred implementation shown in FIG. 11, a New Application Folder window 238 appears when a user selects a corresponding menu selection when seeking to add a new layout configuration for a new application, in this case Microsoft Word (winword.exe) enables the user to select one or more (including all) of the following layout configuration selections: “Default” 240 (highlighted in FIG. 11)—which is the default layout configuration that appears on the displays 110 of the function display keys 32a-32l of the display keyboard 38 when the application is first executed on the processor-equipped apparatus, “Shift” 242 (highlighted in FIG. 11)—which is the layout configuration that appears on the displays 110 of the function display keys 32a-32l for the associated software application when the Shift key is pressed by a user, “Alt” 244—which is the layout configuration that appears on the displays 110 of the function display keys 32a-32l for the associated software application when the Alt key is pressed by a user, “Control” 246—which is the layout configuration that appears on the displays 110 of the function display keys 32a-32l for the associated software application when the Ctrl key is pressed by a user, “Shift-Control” 250 (highlighted in FIG. 11)—which is the layout configuration that appears on the displays 110 of the function display keys 32a-32l for the associated software application when the Shift-Ctrl key combination is pressed by a user, “Control-Alt” 252—which is the layout configuration that appears on the displays 110 of the function display keys 32a-32l for the associated software application when the Ctrl-Alt key combination is pressed by a user, “Shift-Control-Alt” —254 which is the layout configuration that appears on the displays 110 of the function display keys 32a-32l for the associated software application when the Shift-Ctrl-Alt key combination is pressed by a user, and so forth.

In the building of a layout configuration, images are selected by the user and associated with a display 110 of a specific display-equipped input 32a-32l for the particular layout configuration being built, the “Finish” button 256 is selected to associate and store the layout configuration as a specific configuration, e.g. 240-254, of a particular holder 212, 214 or 216. Each image can be associated with a display 110 of a particular display-equipped input 32a-32l by dragging the image onto the display 110 of the particular display-equipped input 32a-32l and dropping it on its corresponding display-equipped input icon shown adjacent the top of the layout pane 203 of the layout configuration builder 205.

Each layout configuration can be stored as a linked list or series of records in a database, data file, lookup table, or the like. In one implementation, all layout configurations are stored in a database, data file, lookup table or the like with each layout configuration being a list of records, each of which holds image data, such as in hexadecimal format, an associated display-equipped input ID designating which display-equipped input is to display the particular image from the associated image data, as well as a variable or ID that indicates which layout configuration or holder to which the set of data belongs. Each of these pieces of data can be stored in its own field of a record associated with a particular display-equipped input, particularly where display-equipped input ID data is omitted (such as when not needed). Other ways, arrangements and the like of storing and associating image data, display-equipped input ID data, layout configuration and layout configuration holder information, and other related information can be implemented in software, firmware or the like.

In a preferred implementation, tasks, functions and macros are assignable to (1) a specific image, (2) a specific image of a specific layout configuration, (3) a specific display 110 of a particular input 32a-32l, and/or (4) a specific display 110 of a particular input 32a-32l of a particular layout configuration, such as for layout configuration holders 212-216 and/or individual layout configurations, e.g., layout configurations 240-254, of a particular layout configuration holder 212-216, including in the same manner as what images are assigned or otherwise associated as discussed above and shown in the drawing figures. In a preferred implementation, both images and functions, tasks and/or macros can be assigned to layout configurations that are called up and made current such that the images are currently displayed on the displays 110 of one or more of the display-equipped inputs 32a-32l of display input-equipped data entry device 38 based on (1) context, such as where the user is operating in a game, creating or editing a document, or executing an application, and/or (2) occurrence of an event, such as a mouse down event on a particular icon, selection of a menu item, or screen location, e.g., focus, or pressing of a particular key or key combination. In a currently preferred implementation, such changing of the currently active layout configuration is dynamic and can occur in real time during application use and operation by a user. Such task, function and macro information is also stored in a field or other data-holding component of such a record or the like including as discussed above in the preceding paragraph such as in a linked-list, series of records stored in a database, table, data file or the like.

FIGS. 12-16 illustrate a method of operation of a preferred embodiment of an image converter utility 258 at least part of which can be configurable into an Internet Explorer compatible module or plug-in, such as a browser helper object (BHO), which enables an original image, typically much larger in bytes and pixels than an image 228 displayable on a display 110 of a display-equipped manipulable user input 32a-32l, to be converted into a data string representative of the original image but compatible with the lower or smaller resolution, e.g., pixel resolution, of the display 110 of the input 32 for which it is intended to be associated with, linked to, or otherwise provided in a digital data storable layout configuration like that discussed above. In a preferred embodiment, such an image converter 258 is built into at least the image editor 220 of the layout utility 204 shown in FIGS. 8-11 and described above enabling drag-and-drop conversion of original images into input display displayable images 228.

In a preferred conversion method, the original image, such as one of the APPLE-icon image 260, blogger image 262, smiley-face image 264, or GOOGLE toolbar image 266, is read and reduced in size, if needed, by determining a reduction aspect ratio needed to reduce it so it produces a display-equipped input displayable image 228 that can be displayed on a input display 110 of a display-equipped input 32a-32l that is of reduced pixel resolution. These images 260-266 are in a pixilated or pixel based format such that they can be embodied in a JPG, bitmap (.bmp), TIFF or other graphical or image file format that is storable on medium, such as a disk, memory, card, or the like of an apparatus, such as a computer, which is equipped with a processor.

Once reduction is carried out producing a bitmap image having a number of rows and columns of pixels or dots corresponding to that of the resolution of the display 110, a string of data, e.g. an alphanumeric string, is generated having at least one piece of data, e.g. a character, for each pixel location with the value or type of character depending on whether the pixel is to be active, e.g. on, on the display 110 or inactive, e.g. off, on the display 110. Where the display is capable of grayscale image display, the character selected depends on what shade of gray for a particular pixel at the string location corresponding to that pixel location for each display pixel. Where the display is capable of color image display, the character selected depends on what color a particular pixel is to exhibit at the string location corresponding to that pixel location for each display pixel.

In one preferred method implementation, such as is depicted in FIGS. 14-16, the image converter utility 258 converts any target or original image, e.g. images 260-268, into a string of hexadecimal code 270 representative of a display-equipped user manipulable input displayable image of the original image that has a reduced number of pixels as compared to the original image. With reference to FIGS. 14-16, the hexadecimal code 270 is displayed in a field or pane 272 in a window 282 of the converter utility 258, the original image 274 is shown in another pane 276, and the resultant shrunk down input display-compatible image 278 is shown in a smaller pane 280 located next to the original image pane 276.

For example, it does not matter how large the original image is. A method, such as a routine, subroutine, module or the like, is executed by the image converter 258 that scans, parses or analyzes the original image 274 to produce a reduced-pixel hexadecimal code string 270 having at least one hexadecimal character for each pixel of an image 278 of reduced number of pixels that is compatible with a manipulable user input display 110 of a display-equipped input 32a-32l. Where greater bit depth is needed, such as where the display is of gray scale construction (e.g., where each pixel having 0-16 levels of gray) or color construction (e.g., where each pixel having 65,536 or greater number of colors), each displayable image pixel can be assigned a greater number of hexadecimal characters sufficient to suitably convert but keep the resultant displayable image 278 looking very much like the original image 274. During operation, the hexadecimal string 270 is read and converted into bitmap data or another compatible data format for the particular pixel associated with each hexadecimal character or characters of the sting 270 that can thereafter be provided to a driver, such as an LCD driver (FIGS. 6 and 7) onboard the display equipped user manipulable input 32a-32l whose display 110 the image 278 is intended to be displayed on.

FIG. 12 illustrates a preferred embodiment of a window 282 of an image converting software utility 258 capable of taking a pre-existing icon or image, e.g. one of images 260-268, and converting it into a code 270 (FIG. 14) that is in a compressed string format suitable for display on a manipulable input associated display, such as a display 110 disposed onboard a display-equipped manipulable input 32a-32l. An example of a preferred embodiment of a manipulable input associated display disposed onboard a manipulable input is a manually depressible PC display-equipped key constructed in accordance with that disclosed and shown in commonly owned and presently co-pending U.S. application Ser. No. 11/406,948, filed Apr. 18, 2006, the entire disclosure of which is hereby expressly incorporated by reference herein.

The image converting utility 258, e.g. aforementioned image converter, is operable on a processor equipped device that can be a computer, such as a personal computer or the like that is equipped with a display screen, e.g., LCD monitor. As is depicted in FIG. 13, a human interface device (not shown), such as a mouse 48 (FIG. 1), is used to select an icon or image 260 to convert into a manipulable input display image by dragging the image 260′ over a generally rectangular, e.g., square, target area 276 and then dropping it onto the target area 276. At that point, the image converting utility 258 parses or otherwise scans the icon or image that was dropped into the image target pane 276 to produce a corresponding alphanumeric string 270 that is hexadecimal, such as the hexadecimal string 270 shown in the output field 272 of the utility depicted in FIG. 14. It is this string 270 that is representative of an input display image 274 that is read by a processor configured to convert the string 270 back into a pixilated image 278 of reduced pixel construction that is then displayed on an input display.

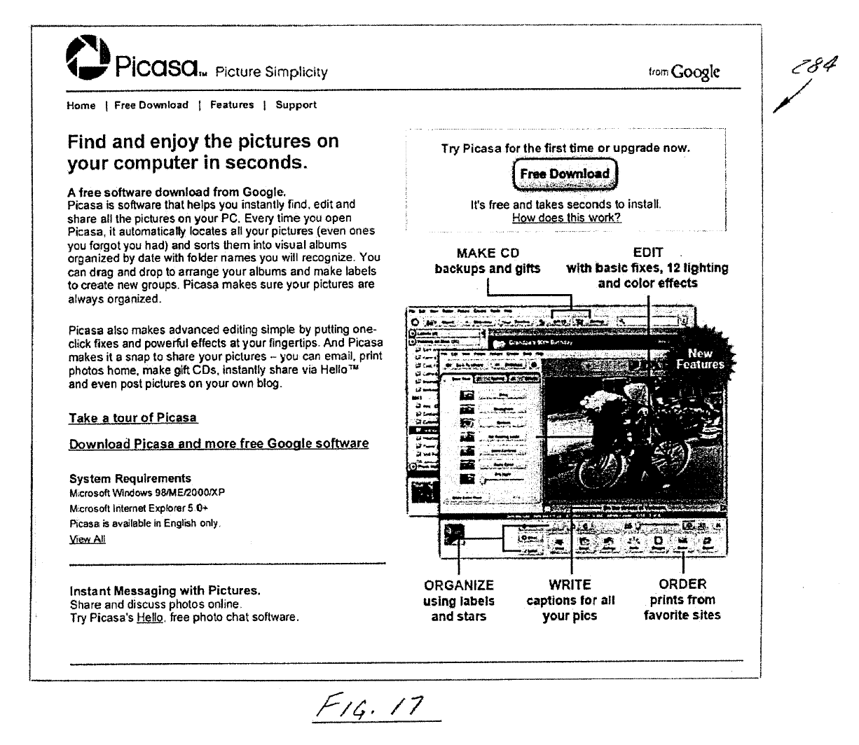

For example, in one preferred embodiment, the processor is located onboard a display keyboard that has a plurality of pairs of display-equipped PC keys. Software or firmware configures the processor so it interprets the Smiley face image 266 into the hexadecimal string 270 shown in the output field 272 in FIG. 16 such that it can be converted or otherwise used to produce pixelated image data that is delivered to a desired or designated display key 32a-32l that displays a reduced pixel Smiley face image on its display 110.

In one preferred embodiment, the image converting utility is configured as a browser helper object (BHO) that is installable so it becomes associated with a Web browser, such as Internet Explorer or the like. Where so equipped, image information 286 shown in FIG. 18 is embeddable into a web page 284 of a web site in a manner that permits a processor equipped apparatus linked or otherwise connected to display-input equipped data entry unit, e.g., display keyboard 30, having at least one manipulable input with a display 110 located adjacent to it, such as a displaceable display-equipped key 32a-32l, which is associated with it.

In one preferred implementation of a method of embedding manipulable input display image data 286, the image converting browser helper object (not shown) accepts an icon or image dragged and dropped onto the web page 282 of the web site into which it is desired to embed image data 286 representative of the icon or image. A conversion routine of the BHO is executed converting the icon or image into image data 288a-288l that is then embedded into the web page 284 in a manner where it need not be displayed on a web page.

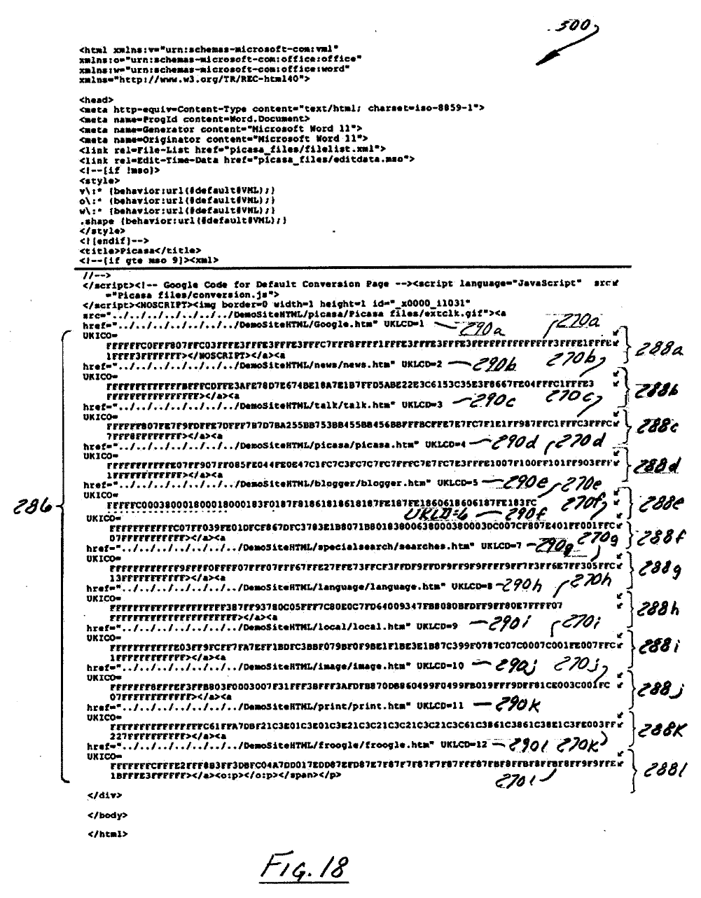

In one preferred implementation, image data 288a-288l (FIG. 18) is embedded into the web page in HTML, XHTML, XML or another Web page format in a manner where the icon or image is not displayed on the web page 284. In a currently preferred embodiment, the image data is embedded in a manner where it remains “hidden” within the desired web page such as is the case for the web page 285 shown in FIG. 17. In a currently preferred implementation, the icon or image is converted into an alphanumeric string 270 that is embedded into the web page 284. In a preferred implementation, the alphanumeric string 270 is a hexadecimal string having at least one digit for each pixel of the manipulable input display 110 of a display-equipped user manipulable input 32a-32l onto which the corresponding icon or image is to be displayed when the web page 284 is viewed by a processor equipped apparatus 36 linked or otherwise connected to an data entry device 30 having at least one manipulable input 32a-32l with a display 110 located adjacent to it, such as a displaceable display-equipped key. For example, where the display input-equipped data entry device 30 is a display keyboard having a plurality of display keys 32a-32l and the processor equipped apparatus 36 is a computer to which the display keyboard is linked, browsing a web page 284 having at least one embedded input display image string, e.g., 270a-270l, in its HTML, XHTML or XML code 300 will cause the string to be read and converted by an application programming interface (API) run by the apparatus in to pixelated image data that is then displayed on the display of at least one of the display keys of the display keyboard.

In one preferred implementation, each string 270a-270l contained in the web page code, e.g. HTML, XHTML, XML or the like, of the web page 284 currently being viewed by a browser is read by a browser helper object (BHO) of the browser. Each hexadecimal string is 270a-270l is read, such as by the BHO and communicated to the display keyboard 30 where it is displayed on the display 110 of a display key 32a-32l that corresponds to a display ID number 290a-290l, shown as an UKLCD number in FIG. 18.

For example, hexadecimal string data 270, like the hexadecimal strings shown in any one of FIGS. 14-16 can be embedded into a web page 284 such that an web browser equipped with a BHO configured in accordance with the present method of the invention reads the strings 270a-270l and ultimately causing the image corresponding to the particular string to be displayed on one of the user input displays 110 typically by passing it off to the API. The string data of each one of the strings 270a-270l is converted into bitmap or other compatible data for enabling the display 110 of each display key 32a-32l to display the corresponding image, e.g. news icon, talk icon, picasa icon, blogger icon, searches icon, language icon, local icon, image icon, image icon, print icon, or froogle icon (see FIG. 18). The corresponding UKLCD number (reference numerals 290a-290l) identify which display key 32a-32l each image corresponding to each string 270a-270l is to be displayed.

The API is configured to carry out or have each hexadecimal string converted into bitmap image data that is ultimately delivered to the display keyboard 38 where it is shown on one of the displays 110 of one of the display keys 32 of the keyboard 38. In a preferred method implementation, function, task and/or macro data or identification information for each image also is embedded into the HTML, XHTML, or XML code 300 of the web page 284 along with the corresponding hexadecimal string data for the image. In a preferred implementation, display key designation data 270a-270l is also embedded in such a manner where it also is associated with a particular image such that each hexadecimal string for each image is assigned to a specific display key. Such data can be embedded into the web page in layout configuration data format and/or as a layout configuration, if desired.

In a preferred implementation, manipulable input display designation data is also embeddable into the web page where image string data of war more than one manipulable input display is embedded. In addition, a flag or other type of data, e.g., null character or the like, can also be embedded into the web page and associated relative to embedded image string data in a manner that makes it easy to detect by an appropriately configured web browser helper object, ActiveX control, OLE object, API, or the like enabling embedded image string data to be quickly detected, read, processed as needed, and displayed on a desired designated manipulable input display. Where image string data for a plurality of icons or images is embedded in a web page, at least one piece of data or the like is further embedded to designate which manipulable input display each image is to be displayed on when read and delivered to its corresponding designated display.

In one preferred implementation, the embedded image information is dynamic, such as a dynamic OLE object, COM object, ActiveX control or the like, thereby enabling a server that is remote from both the web server and the apparatus browsing the web page with the embedded dynamic image information, e.g. link, easily enabling image or icon changes to be easily made by simply changing whatever icon or image string is associated with a particular embedded dynamic link (e.g., dynamic embedded image information).

It is also to be understood that, although the foregoing description and drawings describe and illustrate in detail one or more preferred embodiments of the present invention, to those skilled in the art to which the present invention relates the present disclosure will suggest many modifications and constructions as well as widely differing embodiments and applications without thereby departing from the spirit and scope of the invention.

It is claimed:

1. A method of configuring a display-input equipped data entry device having a plurality of user manipulable display-equipped inputs comprising:
(a) obtaining a first image comprises of a first number of pixels;
(b) converting the first image into a second image appearing substantially similar to the first image but having a second number of pixels less than the first number of pixels; and
(c) causing the second image to be shown on a display of one of the plurality of user manipulable display-equipped inputs.

2. The method of claim 1 wherein during the conversion step the first image is converted into a non-image code that is representative of the second image.

3. The method of claim 2 wherein the non-image code comprises a hexadecimal code.

4. The method of claim 2 wherein the code is embedded into a web page document that is readable by a browser to produce a viewable web page.

5. The method of claim 4 wherein the embedded code is readable from the web page document of the web page currently being viewed and displayable in a browser window on a display of one of the plurality of display-equipped inputs.

6. The method of claim 5 wherein there is a plurality of codes and display-equipped input designation data embedded into the web page document of the web page currently being viewed.

7. The method of claim 6 further comprising a browser module or plug-in of the browser that scans coding in a web page document of a currently viewed web page and retrieves each embedded image code.

8. The method of claim 7 wherein the browser plug-in or module comprises a browser helper module that is configured to scan for an image code in a web page document read by the browser.

9. The method of claim 8 wherein each scanned image code is communicated to the display-input equipped data entry device such that an image based on the image code is shown on a display of one of the plurality of display-equipped inputs.

10. The method of claim 9 wherein the image code comprises a hexadecimal code having at least one character for each pixel of the image corresponding to the image code that is displayable on a display of one of the plurality of display-equipped inputs.

11. The method of claim 1 wherein the software application comprises a browser.

12. The method of claim 11 wherein monitoring is performed in step (d) using a plug-in or module integrated into the browser that monitors websites and cause an image displayed in step (d) to change in response to a website being browsed by the browser.

13. The method of claim 12 wherein the plug-in or module comprises a Browser Helper Object that monitors the IP address of the websites being browsed by the browser and causes an image displayed in step (d) to change in response to the IP address of the website being browsed by the browser.

14. The method of claim 12 wherein the plug-in or module comprises a Browser Helper Object that searches for embedded code in a web page being browsed by the browser and causes an image displayed in step (d) to change when data entry input display related image data is found embedded in the web page being browsed by the browser.

15. The method of claim 14 wherein an image code comprises hexadecimal data that is converted in a further step into image data displayable on a display of a display-equipped data entry input.
